(19) United States
(12) Patent Application Publication
(10) Pub. No.: US 2013/0346680 A1
(43) Pub. Date: Dec. 26, 2013

(54) EMULATED ELECTRICALLY ERASABLE MEMORY HAVING AN ADDRESS RAM FOR DATA STORED IN FLASH MEMORY

(71) Applicants: Ross S. Scouller, Austin, TX (US); Frank K. Baker, JR., Austin, TX (US); Ronald J. Syzdek, Austin, TX (US)

(72) Inventors: Ross S. Scouller, Austin, TX (US); Frank K. Baker, JR., Austin, TX (US); Ronald J. Syzdek, Austin, TX (US)

(21) Appl. No.: 13/530,169

(22) Filed: Jun. 22, 2012

(51) Int. Cl. G06F 12/02

(52) U.S. Cl. 711/104; 711/E12.008

(57) ABSTRACT

A memory system comprises a memory controller, an address RAM coupled to the memory controller, and a non-volatile memory coupled to the memory controller. The non-volatile memory has an address portion and a data portion. The address portion of the non-volatile memory provides data portion addresses and data portion addresses of valid data to the memory controller. The memory controller loads the data portion addresses and stores them in the address RAM at locations defined by the data portion addresses of valid data into the address RAM. The memory controller uses the data portion addresses, and locations of data blocks within the address RAM, to locate the data blocks within the data portion of non-volatile memory. The memory controller uses the data portion addresses, and locations of the data block addresses within the address RAM, to locate data blocks within the data portion of non-volatile memory

### BACKGROUND

1. Field

This disclosure relates generally to memory systems, and more specifically, to emulated electrically erasable (EEE) memory.

2. Related Art

Emulated electrically erasable (EEE) memories typically use a random access memory (RAM) and a non-volatile memory such as flash memory that is electrically erasable combined to provide a memory system that has increased endurance over a regular non-volatile memory for a comparable size to that of the RAM. This is achieved using a non-volatile memory much larger than the RAM but EEE memory operates as if it were only the size of the RAM. Thus the EEE memory emulates an electrically erasable memory of a reduced size from that which is used by the EEE memory but with an increase in endurance.

EEE memories use the RAM to display the contents of the emulated memory, but become non-competitive when the intended emulated EEprom becomes large. Elimination of the RAM means slow access time via search based methodologies.

Accordingly, there is a need to provide an EEE memory that improves upon the issue described above to allow the non-volatile flash memory to be competitive with electrically-erasible programmable read-only memory (EEPROM).

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates in block diagram form an embodiment of a system useful in reading data from a flash memory array.

FIG. 2 illustrates an embodiment of a full address record that can be used in the system of FIG. 1.

FIG. 3 illustrates an embodiment of an address system record that can be used in the system of FIG. 1.

FIG. 4 illustrates an embodiment of an address random access memory that can be used in the system of FIG. 1.

FIG. 5 illustrates an embodiment of a data portion of a flash memory array that can be used in the system of FIG. 1.

FIG. 6 illustrates an embodiment of a record status format that can be used in the data portion of the flash memory array of FIG. 5.

FIG. 7 illustrates an embodiment of a format for a data block that can be used in the data portion of the flash memory array of FIG. 5.

FIG. 8 illustrates in block diagram form another embodiment of a system useful in writing data to flash memory array.

FIG. 9 illustrates a flow diagram of an embodiment of a method for performing a write operation using the system of FIG. 8.

### DETAILED DESCRIPTION

In one aspect an emulated electrically erasable (EEE) memory has a non-volatile memory (NVM) divided into sectors and a random access memory (RAM) for storing address information for the NVM. Address information is stored in a type of RAM memory that allows access to the data records held in the NVM in two clock cycles. The NVM and the address RAM work together to protect against loss of data that can occur during a power supply surge or drop during record creation. Distributed compress/erase operations can be implemented in conjunction with burst program modes to allow for quick response to commands. This is better understood by reference to the drawings and the following description.

In one embodiment, a flash memory is used as the NVM. In one example, and as used herein, programming refers to storing a logic level zero to a bitcell and erasing refers to storing a logic level one to a bitcell. However, in alternate embodiments, programming may refer to storing a logic level one to a bitcell and erasing may refer to storing a logic level zero to a bitcell. A logic level zero may also be referred to as a logic low and a logic level one may also be referred to as a logic high.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

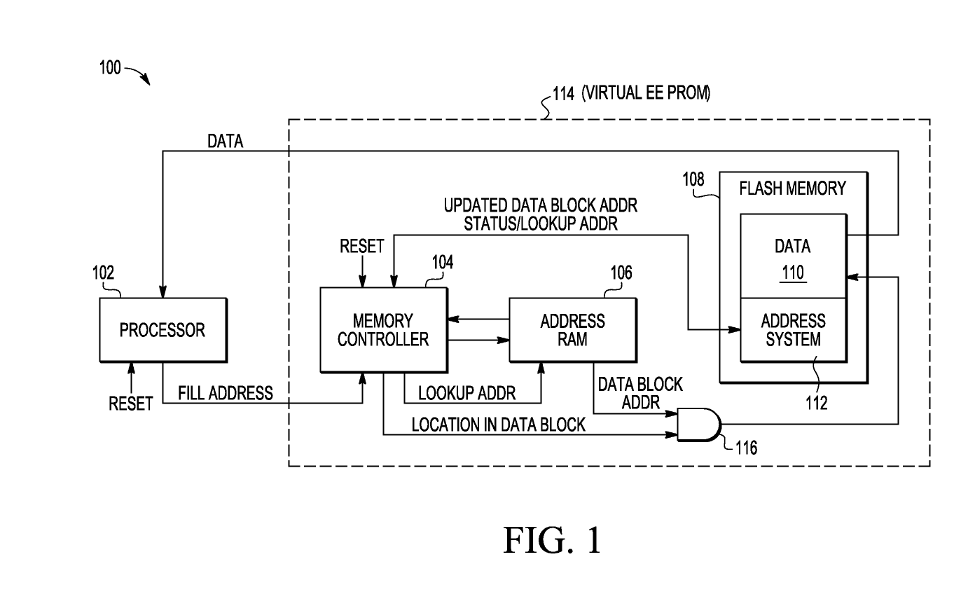

FIG. 1 illustrates in block diagram form an embodiment of processing system 100 useful in reading data from flash memory 108 including a processor 102, and an EEE memory system 114 using non-volatile flash memory array 108 and an address RAM 106. EEE memory system 114 includes a memory controller 104, address RAM 106, and a flash array 108 (which may also be referred to as an NVM array, where any type of NVM may be used in place of the flash memory). Flash array 108 can include one or more data sections 110 and one or more address systems 112. RAM 106, which may be considered a volatile memory, is bidirectionally coupled to memory controller 104. Memory controller 104 is coupled to receive full address records from processor 102, and updated data block addresses from address system 112. Memory controller 104 is further coupled to provide lookup addresses to address RAM 106 and corresponding data portion locations to gate 116. A reset signal is provided to processor 102 and memory controller 104. This reset signal may be, for example, a global reset signal for system 100. Gate 116 receives data portion addresses from address RAM 106 and combines the data portion addresses with corresponding locations in the data blocks, and sends the combined address/block location signal to access the corresponding data block and location within the specified data block in data section 110.

Processor 102 can be any type of processor, such as a microprocessor, digital signal processor, etc., or may be any other type of interconnect master which can access EEE memory system 114. System 100 can also include components that are not shown in FIG. 1 such as a system bus or other forms of interconnect such as, for example, crossbars, point-to-point connections, and optical and wireless transmission components, other memory, one or more additional processors, one or more peripherals, one or more input/output (I/O) devices, etc. Alternatively, no other modules or components may be present in system 100.

In operation, processor 102 can send access requests (read or write access requests) to memory system 114. The access requests from processor 102, which include a full address, and, in the case of a write access, associated write data, are provided to memory controller 104. The full address includes a lookup address and the corresponding location in the data block associated with the lookup address. Address RAM 106 includes a table that translates the lookup addresses to a corresponding data portion address. In the case of a read access, data section 110 provides processor 104 the data corresponding to the location specified by the full address. In the case of a write access, data section 110 stores the received write data as new records at the received address location. In the case of a write access, memory controller 104 may detect an update of flash array 108 and provide updated data block addresses from address system 112 to address RAM 106.

As an example with an address system 112 that uses 32 bit records, the top 16 bits can hold a 64 byte location within a 128 k EEE image. The lower 16 bits point to the physical location of a 64 byte block within the data portion 110. For a 128 k EEE image with 64 byte blocks, 8 k of flash memory would include 2 k for address locations within address system 112. The entire system can include two or more EEE images, and would require 8 k of flash memory for each EEE image.

The physical address of all 64 byte blocks is transferred into address RAM at the address corresponding to the 64 byte offset in the upper word. The transfer process can be automated using test logic with an overhead of 1 cycle per record within the 8 k address system 112. Thus, updating the address RAM 106 for a system with an 8 k address system 112 would require 10 us for a 25 mHz clock rate.

Blocks in data portion 110 can be read as a standard electrically erasable programmable read-only memory in two automated steps that include (1) removing upper address bits from a lookup address to determine the data portion address in address RAM 106, and (2) combining the data portion address with the location of the data in the data section 110 to access the specific data within the data section 110. The automated steps each require 1 clock cycle.

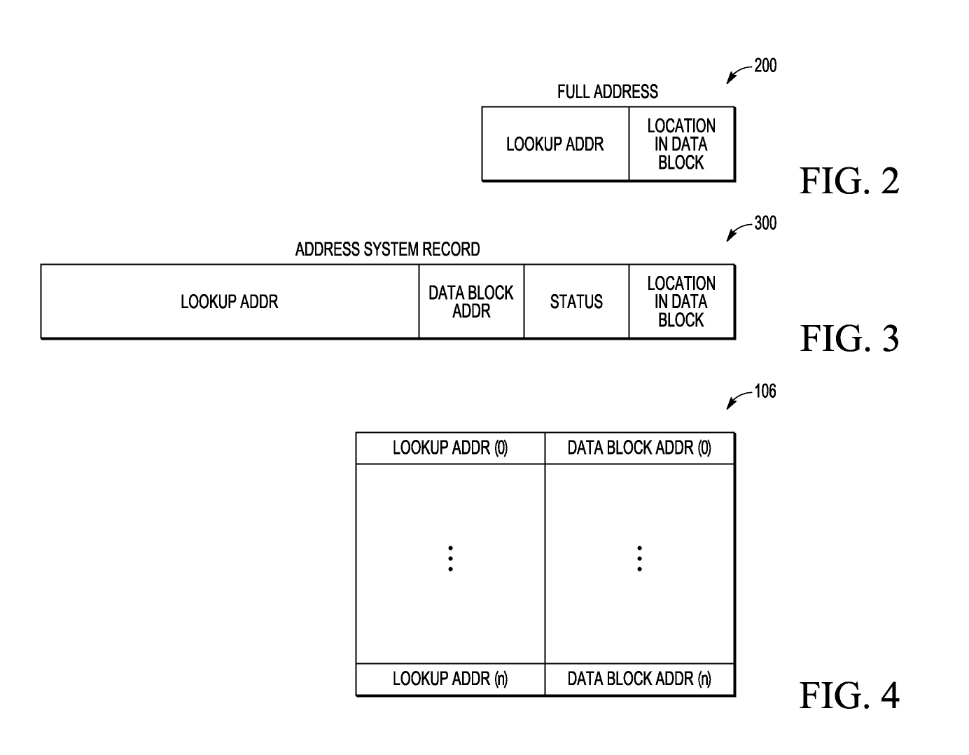

FIG. 2 illustrates an embodiment of a full address 200 that can be used in the system 100 of FIG. 1. Full address 200 is sent from processor 102 to memory controller 104 along with a read or write request and includes the lookup address and the location within the data block to be accessed. The lookup address is translated to a data portion address in the address RAM 106. The data portion address and the location in the data block are combined by gate 116 and used to access a specific location in a data block in data section 110 of flash array 108.

FIG. 3 illustrates an embodiment of an address system record 300 that can be used in the system 100 of FIG. 1. Address system record 300 is one of multiple address system records 300 that can be implemented in address system 112 (FIG. 1) and can include a lookup address field, a data portion address field, a status field, and a block select field. The information from the lookup address field and location in data block is provided by address RAM 106 to populate the lookup address and data portion address fields in record 300. Information for the status field and the data portion address field in record 300 is provided by memory controller 104. A qualifying status bit can be used to determine the existence of a record in the address system 112, so all 0's can indicate no record.

FIG. 4 illustrates an embodiment of an address RAM 106 that can be used in the system of FIG. 1 that includes a table of lookup addresses (0) through (n) and corresponding data portion addresses (0) through (n). When address RAM 106 receives a lookup address from memory controller 104, address RAM 106 retrieves the corresponding data portion address and sends the data portion address to gate 116. Note that data portion addresses and locations in the data block can be sent separately to data section 110 instead of via gate 116. The number and size of the lookup addresses and data portion addresses can be based on the size of flash array 110.

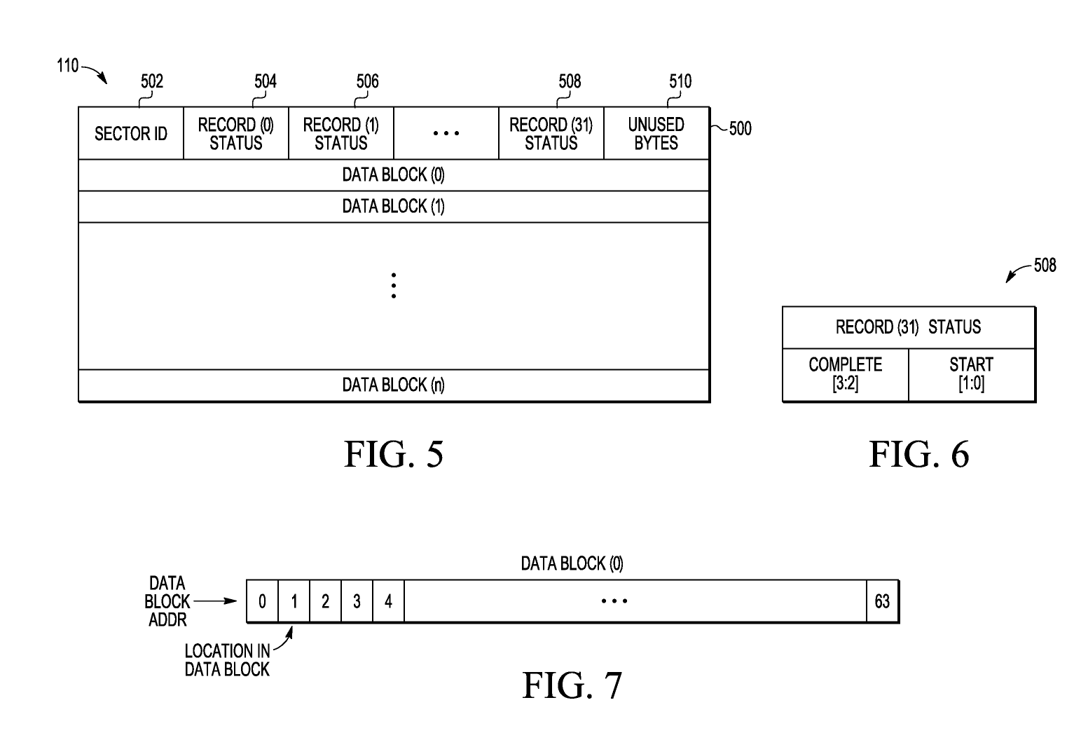

FIG. 5 illustrates an embodiment of a data portion 110 of flash memory array 108 that can be used in the system 100 of FIG. 1 including status record 500 and data blocks (0) through (n). Status record 500 can include a sector identification field 502, record status fields 504-508, and unused bytes 510. The sector identification field 502 identifies the sector in the flash memory array 108. The record status fields 504-508 include information regarding whether a write to a corresponding block in the flash memory array 108 has started or completed.

FIG. 6 illustrates an embodiment of a format for record status fields 504-508 that can be used in the data portion 110 of the flash memory array shown in FIG. 5. As an example, record status field 508 can have 4 bits, with 2 bits reserved to indicate whether an operation such as a write command, has started, and another two bits to indicate whether the operation has completed. Other suitable formats for record status fields 504-508 can be used.

The unused bytes 510 can be used as record status fields for additional blocks, tracking sector erase counts, or left unused, depending on the size of data portion 110.

FIG. 7 illustrates an embodiment of a format for data block (0) that can be used in the data portion 110 of the flash memory array 108 of FIG. 5. Note that the same format can be used for data blocks (1) through (n). Data block (0) is accessed using the data portion address, and each byte in data block (0) can be accessed using the location in the data block (0), as provided by gate 116 (FIG. 1) or other suitable technique or mechanism. Although data block (0) is shown having 64 bytes, data block (0), as well as data blocks (1)-(n), can have any suitable number of bytes.

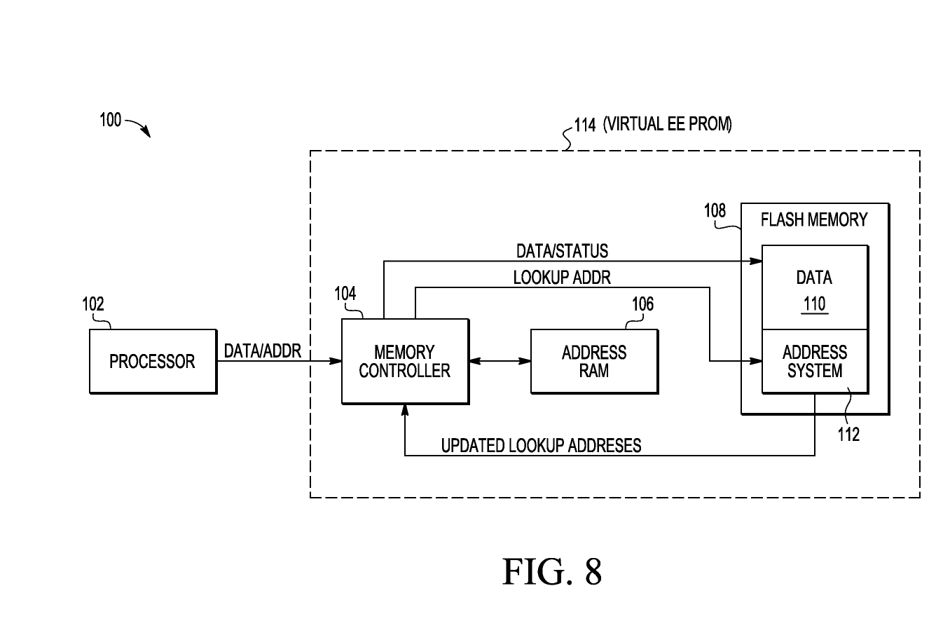

FIG. 8 illustrates in block diagram form another embodiment of system 100 useful in writing data to flash memory 108. Processor 102 provides data to be written along with an address to write the data to memory controller 104. Memory controller 104 sends the data to the desired address of data portion 110 in flash array 108. Status information, such as whether a write has been started or completed for a particular data block is also sent to data portion 110. Lookup and data portion addresses and status information can also be sent to address system 112 of flash array 108 to keep track of data portion 110. Memory controller 104 can also communicate with address RAM 106 to provide updated data block addresses after a system reset or other event that requires an update to one or more lookup addresses and/or corresponding data portion addresses.

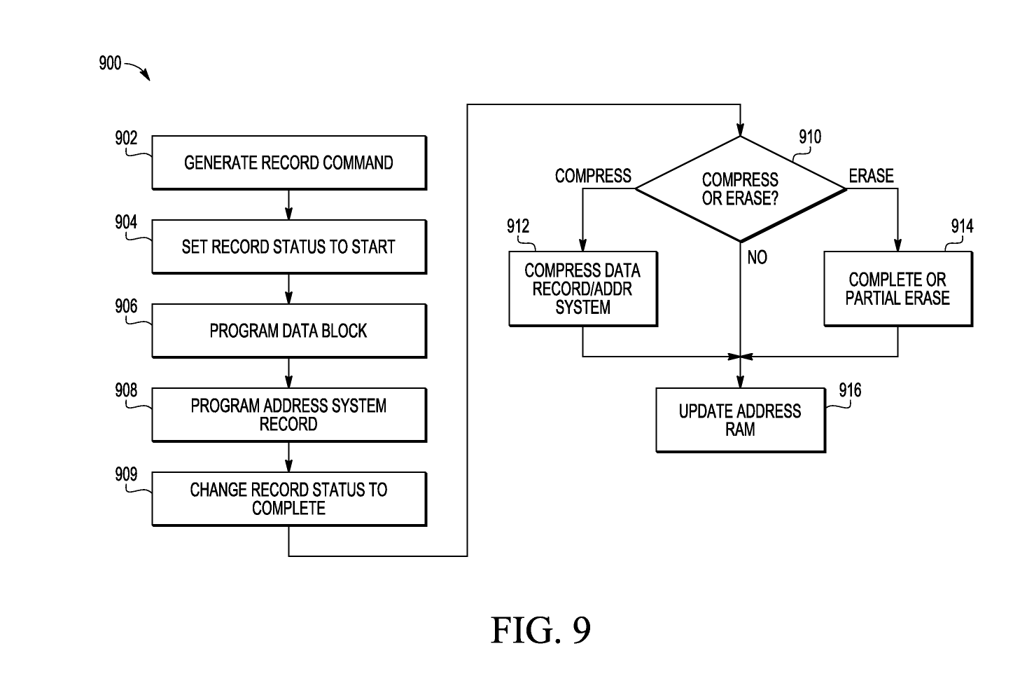

FIG. 9 illustrates a flow diagram of an embodiment of a method 900 for performing a write operation using the system 100 of FIG. 8. Process 902 can include generating a record command that includes writing data to flash memory array 108. The record command can be generated by sending a command along with data and an address from processor 102 to memory controller 104.

Process 904 can include determining a setting for record status fields 504-508 (FIG. 5) to indicate that a write operation is in progress and updated data will be available in the corresponding block once the write operation is complete.

Process 906 can include programming or writing to the data block. Note that data can be written to either a single bit in the flash array, dr a burst program mode can be used to write to a group of bits with the address giving the starting bit to be written within a block identified by the address. The corresponding record status fields 502-508 can also be written in data portion 110 as part of process 906. A single write operation, as opposed to a burst write operation, can be used to write to one of the record status fields 502-508.

Process 908 can include writing the data portion address and the location in the data block to the address system 112. The data portion address and the location in the data block corresponds to the data being written to data portion 110. Note that no search is required to determine the data portion address since the information is readily determined using the lookup address in the address system 112.

In process 909, memory controller 104 changes the record status to complete and sends the updated record status to flash array 108.

Process 910 can include determining whether a compress or an erase operation is to be performed. In accordance with the determination that a compress operation will be performed in process 910, process 912 can compress the input data according to a predetermined compression algorithm, thereby reducing the size of data stored in the memory block. In accordance with the determination that an erase operation will be performed in process 910, process 914 performs an erase operation during which data stored in one or more pages in a single block are sequentially erased;

After process 912 or 914 is performed, or after process 910 determines that no compress or erase operation is to be performed with the write operation, process 916 includes updating memory controller 104 and address RAM 106 with updated lookup addresses from address system 112.

As an example, Table 1 below shows the time required to perform method 900:

TABLE 1
EXAMPLE TIME REQUIRED FOR
RESPECTIVE PORTIONS OF PROCESS 900

| | |
|---|---|
| Process 904: Set Record Status to Start. | 100 us |
| Process 906: Program data using burst mode. 5 us per byte + | 420 us |
| status bits | |
| Process 908: Program Address record containing Address and | 50 us |
| record location. | |
| Process 910: No search required use address from cache. | 0 us |
| Process 912: A compress/ copy of two 64 byte records + mark | 840 us |
| as erase | |
| Process 914: A partial erase pulse 20 ms /32 | 625 us |
| Process 912: Compress address records | 150 us |
| Process 914: Alternate erase of address system or have ability to | 625 us |
| simultaneously select with data system | |
| Process 916: Change Record Status to Complete. | 50 us |
| As blocks are consumed additional program overhead will be | 100 us |
| experienced. | |
| Total worst path time | 1.71 ms |

When system 100 is used for a copy down process, the data portion address and corresponding lookup addresses need to be provided to the address RAM 106, which can be accomplished by only copying records in the active sectors in the address system 112 to the address RAM 106. No search is required since the data record location can be obtained from the address RAM 106. The address records are unique and as such can be added and differentiated easily during a compression.

By now it should be appreciated that there has been provided systems and methods that use separate record systems for addresses and data to manage EEE image(s) in data portion 110. Read access to the data portion 110 is performed via the address RAM 106 enabling a much larger EE space to be emulated without a large RAM and still have fast read access. Record status fields 504-508 help ensure that data portion 110 is not corrupted during power surges or drop-offs. Additionally, copydown is eliminated for data since only address records need to be copied at reset. Searches for the most recent data in one or more EEE images do not need to be done at any time in system 100. System 100 thus emulates much larger EEE systems than previously possible while improving performance over known EEPROM arrays.

In some embodiments, a memory system comprises a memory controller 104; an address RAM 106 coupled to the memory controller 106; and a non-volatile memory 108 coupled to the memory controller. The non-volatile memory has an address portion 112 and a data portion 110. The address portion 112 of the non-volatile memory 108 provides data portion addresses and lookup addresses of valid data to the memory controller. The memory controller loads the data portion addresses and stores them in the address RAM at locations defined by the data portion addresses of valid data into the address RAM. The memory controller uses the data portion addresses, and locations of data blocks within the address RAM, to locate the data blocks within the data portion of non-volatile memory. The memory controller uses the data portion addresses, and locations of the data portion addresses within the address RAM, to locate data blocks within the data portion of non-volatile memory.

In another aspect, the memory system can further comprise a processor coupled to the data portion of the non-volatile memory. Responsive to a system address provided by the processor, the address RAM provides, to the non-volatile memory, a data portion address from a location in the address RAM selected by the system address.

In another aspect, the system address can comprise a lookup address that identifies a location in the address RAM.

In another aspect, the system address further comprises a data portion address, the memory system can further comprise a logic gate 116 that combines a data portion address provided from the address RAM with the data portion address to select valid data from the data portion 110.

In other embodiments, a method of operating a memory system 100 having a non-volatile memory (NVM), can comprise identifying a first NVM location in the NVM, wherein the first NVM location has first valid data; loading, in a first RAM location of an address RAM 106, an address of the first NVM location; providing a system address for selecting the first RAM location; responsive to the system address for selecting the first RAM location, providing the address of the first NVM location to the NVM from the address RAM; and providing the first valid data from the first NVM location in response to receiving the address of the first NVM location from the address RAM.

In another aspect, the identifying the first NVM location is further characterized by the first NVM location having additional valid data; and the providing the system address is further characterized by the system address having a first portion for selecting the first RAM location and a second portion for selecting the first valid data from among the first valid data and the additional valid data.

In another aspect, the method can further comprise writing the first valid data and the additional valid data into the NVM location as part of a burst operation.

In another aspect, the method can further comprise compressing valid data in the NVM by copying the valid data from sectors that include invalid data into one or more sectors that include only the valid data; and changing a status indicator for each of the sectors that include only the invalid data.

In another aspect, the method can further comprise providing second valid data to be written to the NVM to the memory controller with a corresponding system address; and writing the second valid data into a second NVM location in a data portion of the NVM using an address system of the NVM.

In another aspect, the method can further comprise loading the address RAM with the location of the second valid data.

In another aspect, the method can further comprise providing the address corresponding to the second valid data; obtaining the location of the second valid data from the address RAM; and providing the location of the second valid data obtained from the address RAM to the NVM to obtain the second valid data from the NVM.

In another aspect, the second valid data can be obtained from the data portion 110 of NVM.

In another aspect, the data portion can include status information.

In another aspect, the data portion can comprise data blocks wherein access to a location includes a combination of identifying the data block and a location within the data block.

In another aspect, during a read, the location within the data block is provided by the system address and the identification of the data block is from the address RAM.

In still other embodiments, a memory system 100, comprises a non-volatile memory 108 having a data portion 110 and an address system 112; a data processor 102 that writes data to the data portion according to system addresses; a memory controller 104, coupled to the non-volatile memory and the processor, for receiving the system addresses and the data; and an address RAM 106, coupled to the memory controller, that provides look-up addresses that correspond to system addresses. The memory controller can provide the look-up addresses to the address system and writes data into locations in the data portion selected by the look-up addresses.

In another aspect, the data portion can store status information.

In another aspect, the data portion stores sector ID information.

In another aspect, the data processor can read data from the data portion according to system addresses, the memory controller can obtain data portion addresses from the address RAM corresponding to system addresses and provides the data portion addresses to the address system to identify locations in the data portion for reading, and the data portion can provide data to the processor from locations corresponding to the data portion addresses.

In another aspect, the data portion can have data blocks and the addresses can each have a data block portion and a location in data block portion.

In another aspect, during a read, the nonvolatile memory can receive a selection address that is a combination 116 of the location in data block from the system address and the data block portion from the RAM address.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

The following are various embodiments of the present invention.

What is claimed is:

1. A memory system, comprising:
a memory controller;
an address random access memory (RAM) coupled to the memory controller; and
a non-volatile memory (NVM) coupled to the memory controller;
wherein:
the non-volatile memory has an address portion and a data portion;
the address portion of the non-volatile memory provides data portion addresses and lookup addresses of valid data to the memory controller;
the memory controller loads the data portion addresses and stores them in the address RAM at locations defined by the lookup addresses of valid data; and
the memory controller uses the data portion addresses, and locations of the data block addresses within the address RAM, to locate data blocks within the data portion of non-volatile memory,

2. The memory system of claim 1 further comprising a processor coupled to the data portion of the non-volatile memory, wherein:
responsive to a system address provided by the processor, the address RAM provides, to the non-volatile memory, a data portion address from a location in the address RAM selected by a lookup address.

3. The memory system of claim 2, wherein the system address comprises the lookup address that identifies a location in the address RAM.

4. The memory system of claim 2, wherein the system address further comprises a data portion address, the memory system further comprising a logic gate that combines a data portion address provided from the address RAM with the location in the data block to select valid data from the data portion.

5. A method of operating a memory system having a non-volatile memory (NVM), comprising:
identifying a first NVM location in the NVM, wherein the first NVM location has first valid data;
loading, in a first random access memory (RAM) location of an address RAM, an address of the first NVM location;
providing a system address for selecting the first RAM location;
responsive to the system address for selecting the first RAM location, providing the address of the first NVM location to the NVM from the address RAM; and
providing the first valid data from the first NVM location in response to receiving the address of the first NVM location from the address RAM.

6. The method of claim 5 wherein:
the identifying the first NVM location is further characterized by the first NVM location having additional valid data; and
the providing the system address is further characterized by the system address having a first portion for selecting the first RAM location and a second portion for selecting the first valid data from among the first valid data and the additional valid data.

7. The method of claim 6 further comprising:
writing the first valid data and the additional valid data into the NVM location as part of a burst operation.

8. The method of claim 7 further comprising
compressing valid data in the NVM by copying the valid data from sectors that include invalid data into one or more sectors that include only the valid data; and
changing a status indicator for each of the sectors that include only the invalid data.

8. The method of claim 5, further comprising:
providing second valid data to be written to the NVM to the memory controller with a corresponding system address; and
writing the second valid data into a second NVM location in a data portion of the NVM using an address system of the NVM.

9. The method of claim 8, further comprising loading the address RAM with the location of the second valid data.

10. The method of claim 9, further comprising:
providing the address corresponding to the second valid data;
obtaining the location of the second valid data from the address RAM; and
providing the location of the second valid data obtained from the address RAM to the NVM to obtain the second valid data from the NVM.

11. The method of claim 10, wherein the second valid data is obtained from the data portion of NVM.

12. The method of claim 11, wherein the data portion includes status information.

13. The method of claim 12, wherein the data portion comprises data blocks, wherein access to a location is a combination of identifying the data block and a location within the data block.

14. The method of claim 13, wherein during a read, the location within the data block is provided by the system address and the identification of the data block is from the address RAM.

15. A memory system, comprising:
a non-volatile memory having a data portion and an address system;
a data processor that writes data to the data portion according to system addresses;
a memory controller, coupled to the non-volatile memory and the processor, for receiving the system addresses and the data;
an address random access memory (RAM), coupled to the memory controller, that provides look-up addresses that correspond to system addresses;
wherein:
the memory controller provides the look-up addresses to the address system and writes data into locations in the data portion selected by the look-up addresses.

16. The memory system of claim 15 wherein the data portion stores status information.

17. The memory system of claim 16, wherein the data portion stores sector ID information.

18. The memory system of claim 15, wherein:
the data processor reads data from the data portion according to system addresses;
the memory controller obtains data portion addresses from the address RAM corresponding to system addresses and provides the data portion addresses to the address system to identify locations in the data portion for reading; and
the data portion provides data to the processor from locations corresponding to the data portion addresses.

19. The memory system of claim 18 wherein the data portion has data blocks and the addresses each have a data block portion and a location in data block portion.

20. The memory system of claim 19 wherein during a read, the nonvolatile memory receives a selection address that is a combination of the location in data block from the system address and the data block portion from the RAM address.
